(19) United States
(12) Patent Application Publication
(10) Pub. No.: US 2025/0306969 A1
(43) Pub. Date: Oct. 2, 2025

(54) ACCESS CONTROL TO A SECURED PORTION OF A MEMORY DEVICE FOR ABSTRACTED RESOURCES OF A DATA PROCESSING SYSTEM

(71) Applicant: Dell Products L.P., Round Rock, TX (US)

(72) Inventors: ANKIT SINGH, Bangalore (IN); SHRIKANT U. HALLUR, Bangalore (IN); NAVEEN AWASTHY, Bangalore (IN)

(21) Appl. No.: 18/618,344

(22) Filed: Mar. 27, 2024

(51) Int. Cl. G06F 9/455

(52) U.S. Cl. CPC G06F 9/45558; G06F 2009/45583

(57) ABSTRACT

Methods and systems for managing access to a memory device of a data processing system that is shared between a plurality of abstracted resources hosted on the data processing system are disclosed. A memory device may have a secured portion that one or more of the plurality of abstracted resources wish to write data into. A management entity hosted by the data processing system may facilitate access of each of the abstracted resources to the secured portion of the memory device. Various encryption mechanisms used to gain access to the secured portion may be stored and/or retrieved by the management entity from various sources. The management entity may also configure a write request sequence to ensure that all write requests to the secured portion received from the abstracted resources will be written into the secured portion.

### FIELD

Embodiments disclosed herein relate generally to memory device access control. More particularly, embodiments disclosed herein relate to systems and methods to manage access to one or more memory devices by abstracted resources hosted by a data processing system (e.g., a computing device).

### BACKGROUND

Computing devices may provide computer implemented services. The computer implemented services may be used by users of the computing devices and/or devices operably connected to the computing devices. The computer implemented services may be performed with hardware components such as processors, memory modules, storage devices, and communication devices. The operation of these components and the components of other devices may impact the performance of the computer implemented services. Users may input commands and interact with computing devices using HIDs.

### BRIEF DESCRIPTION OF THE DRAWINGS

Embodiments disclosed herein are illustrated by way of example and not limitation in the figures of the accompanying drawings in which like references indicate similar elements.

FIG. 1A shows a block diagram illustrating a system in accordance with one or more embodiments.

FIG. 1B shows a block diagram illustrating a data processing system in accordance with one or more embodiments.

FIG. 1C shows a block diagram illustrating a management entity in accordance with one or more embodiments.

FIG. 1D shows a block diagram illustrating hardware resources in accordance with one or more embodiments.

FIGS. 2A-2C show data flow diagrams in accordance with one or more embodiments.

FIGS. 3A-3C show flowcharts in accordance with one or more embodiments.

FIG. 4 shows a block diagram illustrating a computing device in accordance with one or more embodiments.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

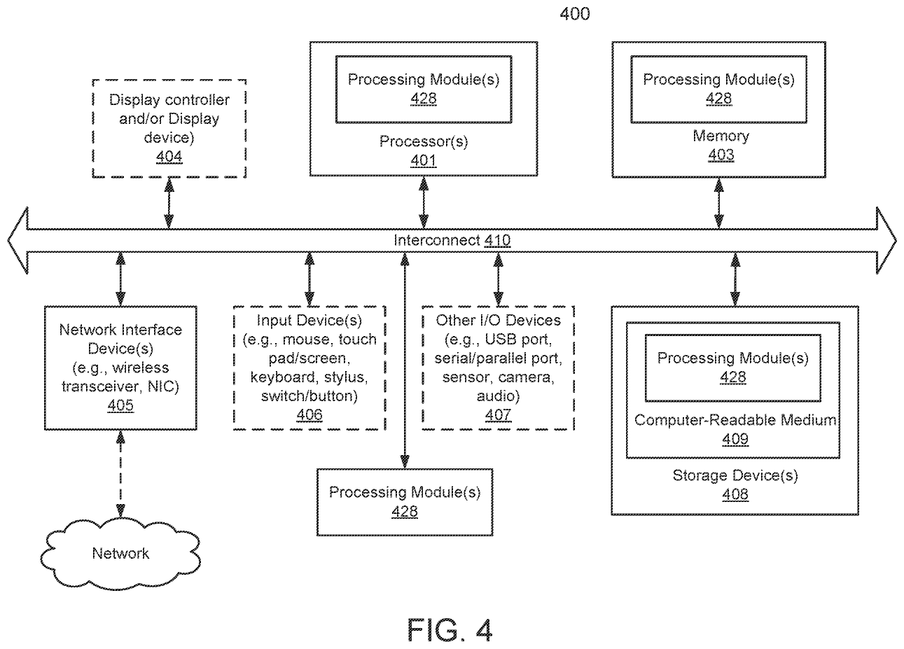

In general, embodiments disclosed herein relate to methods and systems for managing access to a memory device of a data processing system (such as a non-volatile memory express (NVMe) based solid-state drive (SSD), or the like) that is shared between a plurality of abstracted resources hosted on the data processing system (such as computing devices, as described below in reference to FIG. 4).

In particular, memory devices are now provided with secured portions that have tight security for reading and/or writing data into these secured portions. For example, a non-volatile memory express (NVMe) based solid-state drive (SSD) may be configured with a replay protected memory block (RPMB), which is an authenticated, secure storage portion in a specific memory area of the NVMe SSD (e.g., the secured portion of the NVMe SSD).

An authentication mechanism (e.g., a device key) is usually programmed into the secure portion of these memory devices in a secure environment (e.g., a factory in which the memory devices are initialized, packaged, and shipped; or the like). The authentication mechanism may be used for other components (e.g., a processor or the like of a data processing system in which the memory device is installed) to authenticate with the secured portion. For example, in a RPMB of an NVMe SSD, a secure RPMB key (programmed in the secure environment) is used to authenticate with the RPMB protected memory areas of the NVMe SSD (e.g., a boot partition are, or the like) with a message authentication code (MAC) for read and write access to these RPMB protected memory areas of the NVMe SSD. In embodiments, the MAC may be calculated using an HMAC SHA-256 algorithm (that may include, for example, the write data (e.g., a payload), the secure RPMB key, and a read or write counter).

In a virtualization environment containing multiple abstracted resources (e.g., virtual machines (VMs), application containers (also referred to herein as “containers”), or the like), difficulties and inconveniences may be experienced when trying to share the secured portion authentication mechanism between these abstracted resources. For example, using shared authentication mechanism access where the secured portion of the memory device is accessible to only a management VM among a plurality of instantiated VMs may result in an increasing write counter that would eventually lead to unintended de-synchronization of writes to the memory device (e.g., one or more of the write requests may unintentionally be missed. Using a trusted execution environment (TEE) that relies heavily of inter-VM communication may result an increased risk of in inter-VM attacks. Other existing methods of authentication mechanism sharing (e.g., using an ACRN secure storage virtualization environment/architecture) may result in the increased risk of the authentication mechanism being stolen and/or compromised. Further, provisioning multiple secured portions on the memory device (e.g., multiple RPMBs) such that each VM is only associated with one secured portion is not scalable as memory devices have limited partitions to be used for these secured portions. Thus, there an existing technical problem and a long-felt need in the present technical field of embodiments disclosed herein for an improved mechanism of memory device secured portion access in the virtualization environment.

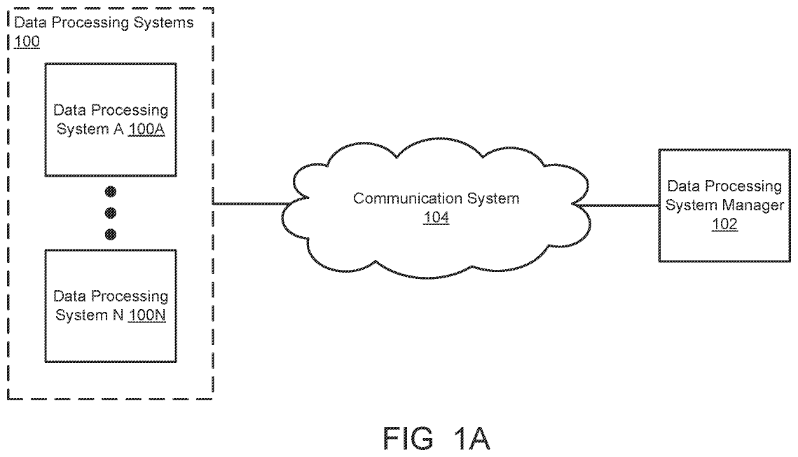

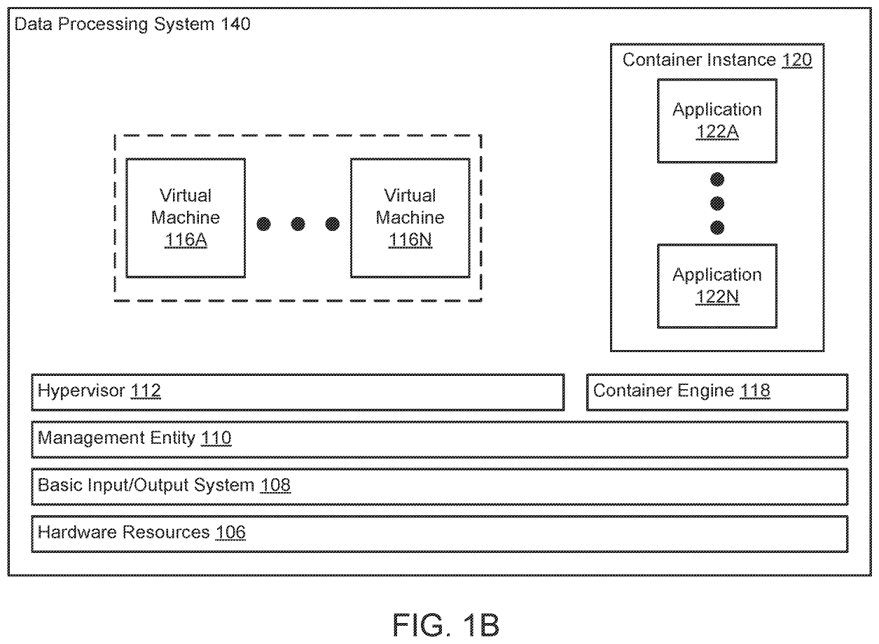

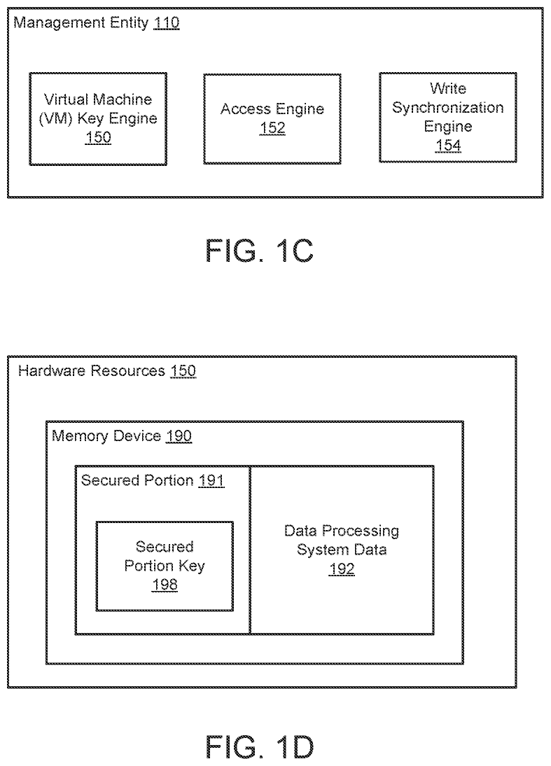

To resolve the above-discussed inconveniences and solve the long-felt need in the present technical field of embodiments disclosed, a management entity (e.g., management entity 110 discussed below in more detail in reference to FIGS. 1B and 1C) may be instantiated and/or configured to facilitate communication and access between the abstracted resources and the secured portion of the memory device.

In particular, the management entity may provision (e.g., assign) a unique VM secured portion access key to each existing VM that is hosted by the data processing system. Each VM may then embed its unique VM secured portion access key in a memory device write request to write data into the secured portion of the memory device.

The management entity may then receive the memory device write request from a VM (e.g., VM1) and verify whether the included VM secured portion access key is the same VM secured portion access key that was previously provisioned for and provided to that VM1. Once verified, the management entity may retrieve a first secured portion key (e.g., a RPMB key, or the like) from a cloud sever (e.g., data processing system manager 102 discussed below in FIG. 1A) and a second secured portion key from the secured portion of the memory device. The second secured portion key may be an additional secret authentication mechanism (e.g., an additional secret RPMB key) that is stored in an extra field created in the secured portion while the memory device is still in the secure environment. The access this extra field, the management entity will still need the default authentication mechanism to access the secured portion of the memory device.

Once the management entity determines that the first secured portion key matches the second secured portion key, the management entity may add the memory device write request to a write request sequence (e.g., a data structure such as a list, table, or the like that stores all of the memory device write requests received by the management entity). The management entity may then write thee write data included in the memory device write request to the memory device based on the write request sequence.

Such operation and key management mechanism of embodiments disclosed herein advantageously allows embodiments herein to: (i) avoid the de-synchronization of writes (namely, using the created write request sequence); (ii) add an additional layer to keep the authorization mechanism of the secured portion of the memory device secret through retrieving two keys from two different sources (e.g., one from the cloud and one from the memory device itself); (iii) reduce and/or eliminate the impact on other VM's secured portion access when one VM among the VMs is compromised; and (iv) improve the secured portion data security as malicious third parties will not be able to easily obtain secured portion access by compromising just one VM (or even the entire data processing system).

Thus, embodiments disclosed herein may provide, among others, an improvement to the above-discussed inconveniences and resolve the long-felt need in the present technical field of embodiments disclosed herein for an improved mechanism of memory device secured portion access in a virtualization environment.

Embodiments disclosed herein also improve the overall functionalities of the data processing system hosting such an abstracted resource architecture (e.g., virtualization environment). In particular, by having a single management entity control the access (e.g., security) to the memory device, there is no longer a need to have each operating abstracted resource to perform (e.g., execute) its own security mechanisms for accessing the secured portion of the memory device. This directly results in the saving of additional computing resources (e.g., computing resource of the data processing system) that may need to be allocated to each abstracted resource to conduct such security mechanisms, and such saved computing resources can be used to enhance the operational capabilities of the data processing system in other ways. Thus, effectively resulting in a direct improvement to the computer functionalities of the data processing system.

In an embodiment, a method for managing access to a memory device of a data processing system that is shared between a plurality of abstracted resources hosted on the data processing system is provided. The method may include: obtaining a memory device write request from a virtual machine (VM) being hosted on the data processing system, the write request comprising at least a VM secured portion access key unique to the VM, a write counter, and write data; making a first determination that the VM has access to the memory device using the VM secured portion access key; in response to the first determination, synchronizing the memory device write request into a write request sequence using the write counter; and writing the write data to the memory device based on the write request sequence.

The memory device write request is for writing the write data into a secured portion of the memory device, writing the write data to the memory device comprises writing the write data into a field of the secured portion, the memory device is non-volatile memory, the secured portion is a relay protected memory block (RPMB) of the non-volatile memory.

The method is performed by a management entity hosted by the data processing system, and the management entity is the only component, among all other components and resources of the data processing system including the VM, that is able to access the RPMB of the memory device.

The VM secured portion access key unique to the VM is created and provisioned to the VM by a VM key engine of the management entity, and operations of the management entity are not accessible to a user of the data processing system through an operating system of the data processing system.

Making a first determination that the VM has access to the memory device using the VM secured portion access key may include: making a second determination that the VM secured portion access key included in the memory device write request matches a VM secured portion access key that was previously issued to the VM before the obtaining of the memory device write request.

Making a first determination that the VM has access to the memory device using the VM secured portion access key may further include: after the second determination, retrieving a first secured portion key from a secured portion of the memory device and a second secured portion key from a data processing system manager that is remote to the data processing system; making a third determination that the first secured portion key matches the second the secured portion key; and in response to the third determination, initiate synchronization of the write data to the secured portion of the memory device.

The first secured portion key is stored in an extra field provisioned in the secured portion of the memory device, the memory device is non-volatile memory, the secured portion is a relay protected memory block (RPMB) of the non-volatile memory.

Retrieving the first secured portion key from the secured portion of the memory device may include using a third secured portion key different from the first secured portion key and the second secured portion key to access the secured portion of the memory device.

The write counter and write data of the memory device write request are encrypted using an encryption protocol.

A non-transitory media may include instructions that when executed by at least a processor of a data processing system cause the computer-implemented method to be performed by the data processing system.

A data processing system may include the non-transitory media and a processor, and may perform the computer-implemented method when processor executes the instructions in the non-transitory media.

Turning to FIG. 1A, a block diagram illustrating a system in accordance with an embodiment is shown. The system shown in FIG. 1A may provide computer implemented services. The computer implemented services may include any type and quantity of computer implemented services. For example, the computer implemented services may include data storage services, instant messaging services, database services, and/or any other type of service that may be implemented with a computing device.

To provide the computer implemented services, a data processing system may execute a method for managing access to a memory device of a data processing system that is shared between a plurality of abstracted resources hosted on the data processing system are disclosed. In particular, a memory device may have a secured portion that one or more of the plurality of abstracted resources (e.g., virtual machines (VMs), containers, or the like) wish to write data into.

In embodiments, a management entity hosted by the data processing system may facilitate access of each of the abstracted resources to the secured portion of the memory device. Various encryption mechanisms (e.g., various keys, or the like) used to gain access to the secured portion may be stored and/or retrieved by the management entity from various sources (e.g., the secured portion of the memory device, a cloud server, or the like). The management entity may also configure a write request sequence to ensure that all write requests to the secured portion received from the abstracted resources will be written into the secured portion.

Thus, the above-discussed improvements of embodiments disclosed herein and the long-felt need in the present technical field of embodiments disclosed herein for an improved mechanism of memory device secured portion access in the virtualization environment may be realized by the data processing system.

To provide the above noted functionality, the system of FIG. 1A may include any number of data processing systems 100 (e.g., data processing systems 100A-100N). Data processing systems 100 may provide the computer implemented services to users of data processing systems 100 and/or to other devices (not shown). Different data processing systems may provide similar and/or different computer implemented services.

To provide the computer implemented services, data processing systems 100 may include various hardware components (e.g., processors, memory modules, storage devices, etc.) and host various software components (e.g., operating systems, application, startup managers such as basic input-output systems, etc.). These hardware and software components (discussed in more detail below in FIG. 1B) may provide the computer implemented services via their operation.

The software components may be implemented using various types of services. For example, each data processing system of the data processing systems 100 may host various services that provide the computer implemented service (e.g., application services) and/or that manage the operation of these services (e.g., management services). The aggregate (e.g., combination) of the management and application services may be a complete service that provide desired functionalities.

To manage the data processing systems 100, the system of FIG. 1A may include data processing system manager 102. Data processing system manager 102 may include various hardware components (e.g., processors, memory modules, storage devices, etc.) and host various software components (e.g., operating systems, application, startup managers such as basic input-output systems, etc.). These hardware and software components may provide the functionalities (e.g., the communication with and management of the data processing systems) of the data processing system manager 102.

In embodiments, data processing system manager 102 may be configured to store one or more additional secret authentication mechanisms (e.g., additional secret RPMB keys) (e.g., in one or more authentication mechanism repositories (not shown in FIG. 1A) configured using one or more storage devices (e.g., memory devices) of the data processing system manager 102). These additional secret authentication mechanisms are then used to match with another instance of additional secure authentication mechanisms stored in extra fields created in secured portions of one or more memory devices installed within the data processing systems 100A-110N.

In the context of embodiments disclosed herein, the term “default authorization mechanism” may refer specifically to the authorization mechanism (e.g., an RPMB key) used to access the secured portion (and the extra field created in the secured portion) while the term “additional secret authentication mechanism” may refer specifically to a secret authentication mechanism (different from the default authorization mechanism) (e.g., an additional secret RPMB key) that is added to the extra field created in the secured portion of the memory device.

In one example, the data processing system manager 102 may be a computing device (e.g., computing device of FIG. 4) such as a desktop computer or server that is used by used by manufacturers (or distributors, administrators, etc.) of one or more components installed within the data processing systems 100 to communicate with and manage (namely, the components installed within) the data processing systems 100.

Any of the components illustrated in FIG. 1A may be operably connected to each other (and/or components not illustrated) with communication system 104. In an embodiment, communication system 104 includes one or more networks that facilitate communication between any number of components. The networks may include wired networks and/or wireless networks (e.g., and/or the Internet). The networks may operate in accordance with any number and types of communication protocols (e.g., such as the Internet Protocol).

While FIG. 1A is illustrated as including a limited number of specific components, a system in accordance with an embodiment may include fewer, additional, and/or different components than those illustrated therein.

Turning to FIG. 1B, a diagram illustrating data processing system 140 in accordance with an embodiment is shown. Data processing system 140 may be similar to any of the data processing systems 100 shown in FIG. 1A.

To provide computer implemented services, data processing system 140 may include any quantity of hardware resources 106. Hardware resources 106 may include physical parts of data processing system 140 that store and run software. Hardware resources 106 may include processors, memory modules (also referred to herein as “memory devices”), storage devices, and/or other types of hardware components usable to provide computer implemented services. A basic input/output system (BIOS) 108 may be stored on the processors and memory modules.

BIOS 108 may be used to startup data processing system 140. On the startup, BIOS 108 may configure peripheral devices, such as a keyboard, mouse, monitor, etc. With the peripheral devices, BIOS 108 may configure hardware resources 106 for use by data processing system 140. After BIOS 108 has configured the peripheral devices and hardware resources 106 for use by data processing system 140, management entity 110 may be activated.

Management entity 110 may be software similar to an operating system that is hosted by a processor of the data processing system 140. Management entity 110 may also be instantiated as any of drivers, network stacks, and/or other software entities that provide various management functionalities. Management entity 110 may interface between hardware and/or software in data processing system 140. Through interfacing, management entity 110 permits the software to access computing resources from the hardware (e.g., the hardware resources 106). Likewise, the hardware facilitates data processing by the software through use of the hardware resources 106. Hypervisor 112 and container engine 118 are software that may use the hardware resources 106 in data processing system 140. In an example of one or more embodiments, the management entity 110 may implemented using one or more Kubernetes-based pods (e.g., a group of one or more containers, with shared storage and network resources, and a specification for how to run the containers).

Hypervisor 112 may include software that enables operation of virtual machines 116A-116N. Each of virtual machines 116A-116N may host an operating system and one or more applications. Upon operation of virtual machines 116A-116N, hypervisor 112 may allocate computing resources (e.g., storage space in a memory device of the data processing system 140) to each of virtual machines 116A-116N from hardware resources 106 through management entity 110.

Alongside hypervisor 112, container engine 118 may host container instance 120. Container instance 120 may run applications 122A-122N. Applications 122A-122N may be run on container instance 120 separately from the OS of the data processing system 140.

Running applications 112A-122N on container instance 120 may require fewer computing resources (e.g., limited resources such as memory space and processing power, or the like, provided through the hardware resources 106) compared to running applications on virtual machines 116A-116N. Container instance 120 may include only necessary libraries, binaries, dependencies, and applications 112A-122N without allocating the computing resources to a separate OS. Thus, container instance 120 may startup faster and run more efficiently than virtual machines 116A-116N. Where computing resources are limited for applications 122A-122N, container instance 120 may be ideal for running applications 122A-122N.

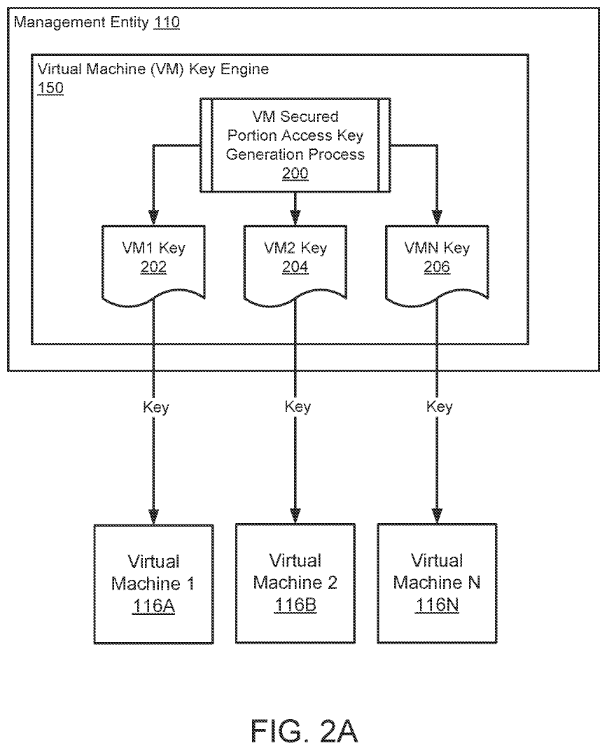

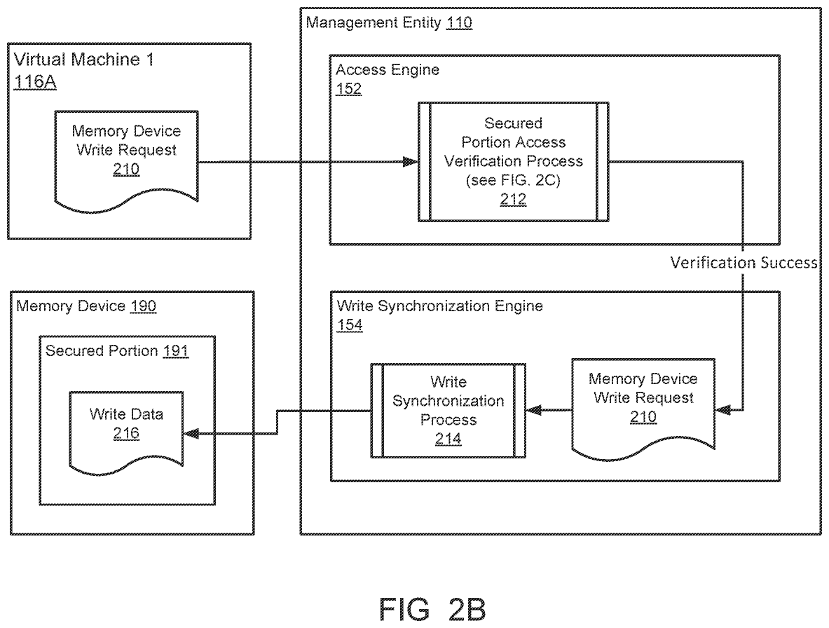

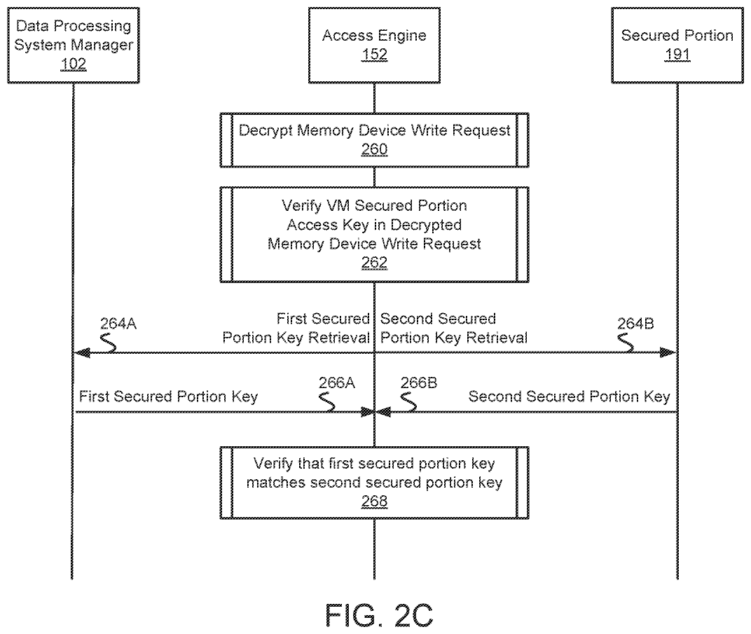

Turning now to FIG. 1C, management entity 110 may be configured to include a virtual machine (VM) key engine 150, an access engine 152, and a write synchronization engine 154. Each of these engines may execute and provide the various management functionalities of the management entity 110 using the processes of embodiments disclosed herein described below in reference to FIGS. 2A-2C.

In embodiments, operations of the management entity are not accessible to a user of the data processing system through an operating system of the data processing system 140. Said another way, a user (e.g., an owner, a customer of a seller of the data processing system 140, of the like) of the data processing system 140 is not given any user access to configured (e.g., modify) the various management functionalities of the management entity 110. In embodiments, only a provider (e.g., a manufacturer, seller, or the like) of the data processing system 140 may have access to configure the various management functionalities of the management entity 110 through remote instructions sent to the data processing system 140 from the data processing system manager 102 of FIG. 1A.

Turning now to FIG. 1D, FIG. 1D shows an example of hardware resources 106 of data processing system 140. In this example, the hardware resources 106 in FIG. 1D includes a memory device 190 (e.g., non-volatile memory such as an NVMe SSD) that includes a secured portion 191 (e.g., a relay protected memory block (RPMB), or the like). The secured portion 191 may include a boot partition of the data processing system 140 (and/or of each of the VMs 116A-116N) and may be protected by the RPMB. The secured portion 191 may also include an extra field created (e.g., an extra field created in an RPMB structure) to store a secured portion key 198. This secured portion key 198 may be an additional secret authentication mechanism (e.g., an additional secret RPMB key different from a default RPMB key used to access the RPMB to retrieve the additional secret RPMB key).

To access and modify the secured portion 191, the data processing system 140 must use the management entity 110. Said another way, the data processing system 140 is configured such that, among all components and resources shown in FIG. 1B, only the management entity 110 is authorized to access (and modify the data stored in) the secured portion 191. For example, only the management entity 110 is configured with the default authentication mechanism that is used to authenticate with one or more authentication protocols that protects the secured portion 191 (e.g., a default RPMB key that provides access to the RPMB). More specifically, prevention of undesired, or hacked, code from running on a device (e.g., the data processing system 140) starts with an assurance that the very first piece of code that the processor reads and executes from the storage device (e.g., memory device 190) is legitimate. This initial code, the bootloader, may be located in a boot partition created in the memory device 190 and the boot partition must be write-protected from malware modification (e.g., using RPMB authentication, or the like). Every change to the boot partition requires the enabling procedure by using an authentication (e.g., authentication using the default RPMB key). The secured write-protect mechanism is primarily used to protect the boot code or other sensitive data (e.g., the default RPMB key) on the memory device 190 from changes or deletion by unauthorized applications.

In embodiments, although not shown in FIG. 1D, the secured portion 191 may also include the boot partition of the data processing system 140 (and/or of each VM 116A-116N or container instance 120 hosted by the data processing system 140).

In embodiments, the memory device 190 also include data processing system data 192. The data processing system data 192 may include user data (not shown) (e.g., traffic statistics, packet headers, service requests, operating system calls, file-system changes, files, documents, applications, or the like) associated with a main OS (e.g., that is required to complete a full start up of the OS) of the data processing system.

Turning to FIGS. 2A-2C, data flow diagrams in accordance with one or more embodiments are provided. The data flow diagrams of FIGS. 2A-2C show a process for managing access to a memory device (e.g., memory device 190 of FIG. 1B) of a data processing system that is shared between a plurality of abstracted resources hosted on the data processing system (such as computing devices, as described below in reference to FIG. 4; data processing system 140, FIG. 1B; any of data processing systems 100A-100N, FIG. 1A).

In these diagrams, flows of data and processing of data are illustrated using different sets of shapes. A first set of shapes (e.g., 110, 116A, 116B, 116N, 150, etc.) is used to represent components (e.g., the components of the data processing system discussed above in FIGS. 1B-1D), a second set of shapes (e.g., 202, 204, 206, etc.) is used to represent data structures (e.g., files, packets, or the like), and a third set of shapes (e.g., 200, 212, etc.) is used to represent processes performed by the components to generate data (e.g., the data structures).

Although FIGS. 2A-2C are described specifically using a virtual machine (VM) environment/architecture, one of ordinary skill would appreciate that the processes shown in FIGS. 2A-2C is also applicable to a container environment/architecture.

Starting with FIG. 2A, the virtual machine (VM) key engine 150 of the management entity generates (e.g., as part of operation 200) VM secured portion access keys for each of VMs 116A, 116B, and 116N that are being hosted on data processing system 140 (not shown in FIG. 2A).

Each generated VM key (e.g., VM1 key 202, VM2 key 204, and VMN key 206) is unique. The VM secured portion access keys may be of any size and any length, and may include any combination of characters (e.g., alphabet), numbers, and/or special characters. The structure and length of the VM secured portion access keys may be predefined by a provider of the data processing system 140 (and/or later modified by the provider using the data processing system manager 102).

As shown in FIG. 2A, VM1 116A receives VM1 key 202, VM2 116B receives VM2 key 204, and VMN 116N receives VMN key 206. Upon receiving the respective VM secured portion access keys, each VM 116A, 116B, and 116N may store their respective VM secured portion access key in an encryptor module (not shown) of each VM. The encryptor module of each VM 116A, 116B, and 116N may be configured to encrypt one or more pieces of data (e.g., a packet, a file, etc.) that are generated by each of the VMs 116A, 116B, and 116N.

Before sending the VM secured portion access keys to each of the VMs 116A, 116B, and 116N, the VM key engine 150 may store (e.g., in a data structure such as a list, table, or the like) each of the generated VM secured portion access keys along with information of the specific VM that each VM secured portion access key is sent to (e.g., in a key-value pair format, or the like).

Turning now to FIG. 2B, after the VMs 116A, 116B, and 116N receive their unique VM secured portion access keys, a VM (e.g., VM1 116A) generates a memory device write request 210. The memory device write request may include: (i) the unique VM secured portion access key of VM1 116A; (ii) a payload including data to be written (referred to herein as “write data”) and a write counter; (iii) any relevant information about the VM1 (e.g., a name, an identification (id), and other parameters and/or specifications of VM1); or the like.

In embodiments, the memory device write request 210 may be encrypted using an encryption protocol by the encryptor module of VM1 116A. The encryption protocol may be a SHA256 HMAC encryption. In embodiments, the entirety of the memory device write request 210 may be encrypted. Alternatively, all of the memory device write request 210 excluding the unique VM secured portion access key may be encrypted.

Once generated and encrypted, the memory device write request 210 may be provided (e.g., by VM1 116A) to the access engine 152 of the management entity 110 where the access engine 152 will execute (e.g., perform) a secured portion access verification process 212.

Jumping now to FIG. 2C, FIG. 2C shows a flow diagram describing the secured portion access verification process 212 performed by the access engine 152 in FIG. 2B. In particular, the access engine 152 is configured to verify whether VM1 116A may access the secured portion 191 of the memory device 190 (e.g., whether the write request of VM1 116A to the secured portion 191 can be fulfilled and completed).

In operation 260, the access engine 152 may decrypt the memory device write request 210 to obtain all of the above-discussed components of the memory device write request 210.

In operation 262, the access engine 152 may verify the VM secured portion access key of VM1 116A included in the memory device write request 210 against the VM secured portion access key of VM1 116A that is stored in the management entity 110 (namely, stored by the VM key engine 150 as discussed above in reference to FIG. 2A).

If the two VM secured portion access keys match, the operation proceeds to operations 264A and 264B. If the two VM secured portion access keys do not match, the operation ends and the access engine 152 notifies VM1 116A that VM1 116A cannot access the secured portion 191 of the memory device 190 (e.g., that the memory device write request 210 of VM1 116 has been rejected).

In operation 264A, the access engine 152 communicates with data processing system manager 102 to request retrieval of a first secured portion key. In operation 264B, the access engine 152 communicates with the secured portion 191 of the memory device 190 to retrieve a second secured portion key. Each of the first and second secured portion key may be instances of the above-discussed additional secret authentication mechanism (e.g., additional secret RPMB key) stored in the extra field created in the secured portion 191.

Additionally, in operation 264B, to be able to communicate with the secured portion 191, the access engine 152 must use a third secured portion key (that is different from both the first secured portion key and the second secured portion key) to authenticate itself with the secured portion 191 in order to access the extra field (storing the additional secret authentication mechanism (e.g., additional secret RPMB key)) created in the secured portion 191. This third secured portion key may be the above-discussed default authentication mechanism (e.g., default RPMB key) used to access the secured portion 191 (e.g., the RPMB).

Further, as part of the request to retrieve the first secured portion key from the data processing system manager 102, the access engine 152 may include any relevant information associated with the data processing system 140, the memory device 190, and or other components of the data processing system 140 that would help the data processing system manager 102 identify that the request is for the specific memory device 190 installed in data processing system 140. The data processing system manager 102 may be configured to retrieve the first secured portion key from the one or more authentication mechanism repositories configured/stored in the data processing system manager 102.

In operation 266A, the first secured portion key is retrieved from the data processing system manager 102. In operation 266B, the second secured portion key is retrieved from the secured portion 191 of the memory device 190.

In operation 268, the access engine 152 verifies whether the first secured portion key matches the second secured portion key. If the two keys match in operation 268, then the access engine 152 has successfully verified that VM1 116A may write to the secured portion 191. If the two keys do not match (or if retrieval of any one of the two keys is not possible), the access engine 152 will return a request failure/error notification to VM1 116A, and the memory device write request 210 from VM1 116A will be terminated.

Returning back to FIG. 2B, once the access engine 152 successfully verifies the memory device write request 210, the memory device write request 210 (excluding the VM secured portion access key of VM1 116A) may be provided (e.g., by the access engine 152) to the write synchronization engine 154 of the management entity 110.

The write synchronization engine 154 may be configured (e.g., as part of operation 214, the write synchronization process) to synchronize the memory device write request 210 (that no longer includes the VM secured portion access key of VM1 116A) in a write request sequence (e.g., a data structure such as a list, table, or the like that stores all of the memory device write requests received by the management entity). The memory device write request 210 may be stored in the write request sequence based on the write counter included in the memory device write request 210. This way, even if memory device write requests are received (at or around the same time) from multiple VMs, because each memory device write request is associated with (e.g., includes) a write counter, the write synchronization engine 154 will advantageously avoid any de-synchronization of the simultaneously (or near simultaneously) received memory device write requests. Said another way, all simultaneously (or near simultaneously) received memory device write requests will be processed by the write synchronization engine 154 using the write request sequence without any of the simultaneously (or near simultaneously) received memory device write requests being unintentionally or accidentally dropped by the write synchronization engine 154.

As further part of write synchronization process 214 (e.g., operation 212), the write synchronization engine 154 may write the write data 216 included in the memory device write request 210 into the secured portion 191 of the memory device 190. Similar to the access engine 152, the write synchronization engine 154 may also have the default authentication mechanism (e.g., the default RPMB key). The write data 216 may be written into a field (e.g., a data field, a partition, or the like) of the secured portion 191 of the memory device 190.

In embodiments, the write request sequence may include memory device write requests received from different VMs (e.g., VM1 116A, VM2 116B, VMN 116N) hosted by the data processing system 140. Each of the memory device write requests comprises respective ones of the VM secured portion access key unique to each of the plurality of VMs (or alternatively may not include this data), a write counter, and write data. In embodiments, writing the write data to the memory device 190 (e.g., by write synchronization process 214) using the write request sequence may include using the write counter included in respective ones of the memory device write requests to ensure that all of the memory device write requests are written into the secured portion 191 of the memory device 190.

In embodiments, once a memory device write request is completed (e.g., upon completion of a successful write request of a VM), all of the above-discussed authentication mechanisms (e.g., authentication keys) will be cleared. The process discussed in FIGS. 2B-2C will then be re-initiated following a new memory device write request from the VM.

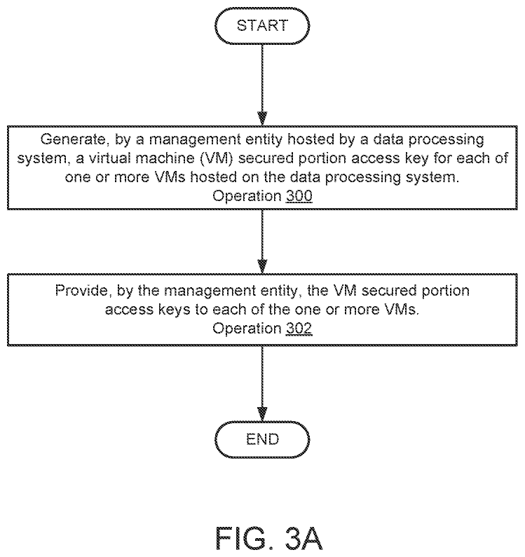

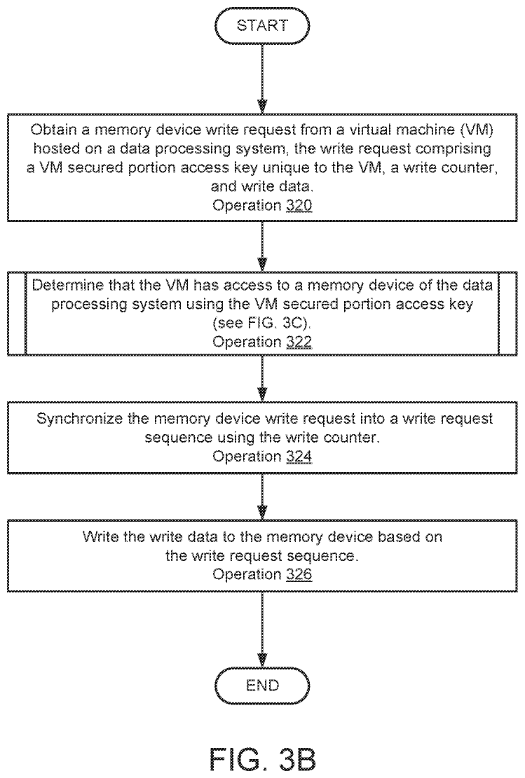

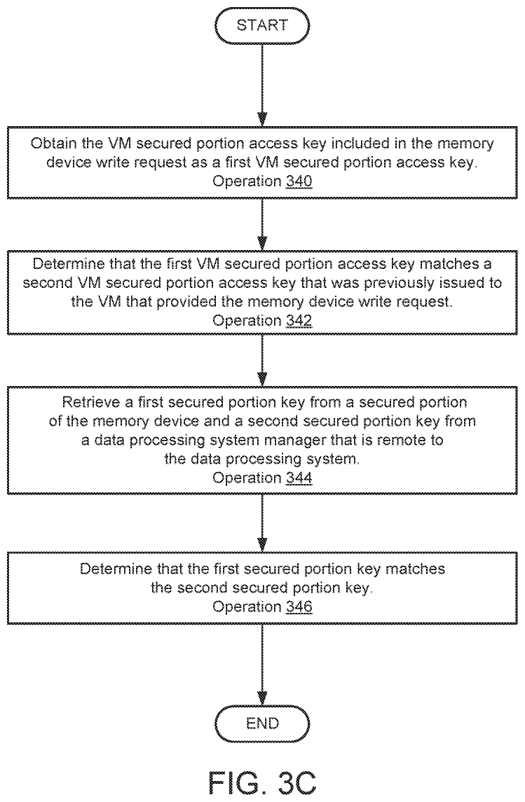

As discussed above, the components of FIGS. 1A-1D may perform various methods for managing a boot up process of a data processing system. FIGS. 3A-3C illustrate examples of methods that may be performed by the components of FIGS. 1A-1D. For example, any of the data processing systems 100 may perform all or a portion of the methods. In the diagrams discussed below and shown in FIGS. 3A-3C, any of the operations may be repeated, performed in different orders, and/or performed in parallel with or in a partially overlapping in time manner with other operations.

Starting with FIG. 3A, in operation 300, a management entity (e.g., management entity 110 of FIG. 1B) may generate (e.g., using VM key engine 150 of FIG. 1C) a virtual machine (VM) secured portion access key for each of one or more VMs hosted on the data processing system.

As discussed above in reference to FIGS. 2A-2C, each generated VM secured portion access key may be unique. Said another way, each VM hosted on the data processing system will receive a different and unique one of the VM secured portion access key. Additionally, the VM secured portion access keys may be generated in any size and any length, and may include any combination of characters (e.g., alphabet), numbers, and/or special characters. The structure and length of the VM secured portion access keys may be predefined by a provider of the data processing system (and/or later modified by the provider using the data processing system manager 102, as shown in FIG. 1A).

In operation 302, the management entity (e.g., via VM key engine) may provide the VM secured portion access keys to each of the one or more VMs. As discussed above in reference to FIG. 2A, each VM may store their respective VM secured portion access key in an encryptor module.

The process may end following operation 302.

Turning now to FIG. 3B, in operation 320 and as discussed above in reference to FIGS. 2A-2C, a memory device write request may be obtained from a virtual machine (VM) hosted on a data processing system. The memory device write request may be obtained by an access engine (e.g., access engine 152 of FIG. 1C) of the management entity. The write request may include a VM secured portion access key unique to the VM, a write counter, and a payload (e.g., write data).

In operation 322, as discussed above in reference to FIGS. 2A-2C as part of secured portion access verification process 212, the VM may be determined (e.g., by access engine 152) to have access to a memory device of the data processing system (namely, a secured portion of the memory device) using the VM secured portion access key. This determination process is shown in more detail in FIG. 3C.

Jumping first to FIG. 3C, in operation 340 of FIG. 3C and as part of operation 322 of FIG. 3B, (as discussed above in reference to FIG. 2C) the VM secured portion access key included in the memory device write request is obtained as a first VM secured portion access key.

In operation 342, as discussed above in reference to FIG. 2C, a determination is made that the first VM secured portion access key matches a second VM secured portion access key that was previously issued to the VM that provided the memory device write request.

In operation 344, discussed above in reference to FIG. 2C, the access engine may retrieve a first secured portion key from a secured portion of the memory device and a second secured portion key from a data processing system manager that is remote to the data processing system.

In operation 346, discussed above in reference to FIG. 2C, the access engine may determine that the first secured portion key matches the second secured portion key. In response to this determination that the first secured portion key matches the second secured portion key, the process of FIG. 3C may end and the overall process (e.g., the process covered by FIGS. 3B-3C) may return to operation 324 of FIG. 3B.

In embodiments, if the first secured portion key does not match the second secured portion key in operation 346 (or if retrieval of any one of the two keys is not possible), the access engine will return a request failure/error notification to the VM that provided the memory device write request, and the memory device write request from the VM will be terminated by the access engine 152.

Returning to operation 324 of FIG. 3B, as discussed above in reference to FIG. 2B, the memory device write request may be provided to a write synchronization engine (e.g., write synchronization engine 154 of FIG. 1C) be synchronized into a write request using the write counter included in the memory device write request.

Finally, in operation 326, the write data included in the memory device write request may be written into the secured portion of the memory device based on a write sequence specified in the write request sequence.

The process (of FIG. 3B) may end following operation 326.

In embodiments, once a memory device write request is completed (e.g., upon completion of a successful write request of a VM), all of the above-discussed authentication mechanisms (e.g., authentication keys) will be cleared. The process discussed in FIGS. 3B-3C will then be re-initiated following a new memory device write request from the VM.

Any of the components illustrated in FIGS. 1A-3C may be implemented with one or more computing devices. Turning to FIG. 4, a block diagram illustrating an example of a computing device (also referred to herein as “system 400”) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high-level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system-on-a-chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a WiFi transceiver, an infrared transceiver, a Bluetooth® transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for managing access to a memory device of a data processing system that is shared between a plurality of abstracted resources hosted on the data processing system, the method comprising:
obtaining a memory device write request from a virtual machine (VM) being hosted on the data processing system, the memory device write request comprising at least a VM secured portion access key unique to the VM, a write counter, and write data;
making a first determination that the VM has access to the memory device using the VM secured portion access key;
in response to the first determination, synchronizing the memory device write request into a write request sequence using the write counter; and
writing the write data to the memory device based on the write request sequence.

2. The method of claim 1, wherein the memory device write request is for writing the write data into a secured portion of the memory device, writing the write data to the memory device comprises writing the write data into a field of the secured portion, the memory device is non-volatile memory, the secured portion is a relay protected memory block (RPMB) of the non-volatile memory.

3. The method of claim 2, wherein the method is performed by a management entity hosted by the data processing system, and, among all other components and resources of the data processing system including the VM, only the management entity is able to access the RPMB of the memory device.

4. The method of claim 3, wherein the VM secured portion access key unique to the VM is created and provisioned to the VM by a VM key engine of the management entity, and operations of the management entity are not accessible to a user of the data processing system through an operating system of the data processing system.

5. The method of claim 1, wherein making a first determination that the VM has access to the memory device using the VM secured portion access key comprises:
making a second determination that the VM secured portion access key included in the memory device write request matches a VM secured portion access key that was previously issued to the VM before the obtaining of the memory device write request.

6. The method of claim 5, wherein making a first determination that the VM has access to the memory device using the VM secured portion access key further comprises:
after the second determination, retrieving a first secured portion key from a secured portion of the memory device and a second secured portion key from a data processing system manager that is remote to the data processing system;
making a third determination that the first secured portion key matches the second secured portion key; and
in response to the third determination, initiate synchronization of the write data to the secured portion of the memory device.

7. The method of claim 6, wherein the first secured portion key is stored in an extra field provisioned in the secured portion of the memory device, the memory device is non-volatile memory, the secured portion is a relay protected memory block (RPMB) of the non-volatile memory.

8. The method of claim 7, wherein retrieving the first secured portion key from the secured portion of the memory device comprises using a third secured portion key different from the first secured portion key and the second secured portion key to access the secured portion of the memory device.

9. The method of claim 6, wherein the write counter and write data of the memory device write request are encrypted using an encryption protocol.

10. The method of claim 1, wherein
the write request sequence includes a plurality of memory device write requests received from different ones a plurality of VMs hosted by the data processing system, the VM being one of the plurality of VMs,
the memory device write request being one of the plurality of memory device write requests,
each of the plurality of memory device write requests comprises respective ones of the VM secured portion access key unique to each of the plurality of VMs, the write counter, and the write data, and
writing the write data to the memory device based on the write request sequence comprises using the write counter included respective ones of the plurality of memory device write requests to ensure that all of the plurality of memory device write requests are written into the memory device.

11. A non-transitory machine-readable medium having instructions stored therein, which when executed by a processor, cause the processor to perform operations for managing access to a memory device of a data processing system that is shared between a plurality of abstracted resources hosted on the data processing system, the operations comprising:
obtaining a memory device write request from a virtual machine (VM) being hosted on the data processing system, the memory device write request comprising at least a VM secured portion access key unique to the VM, a write counter, and write data;
making a first determination that the VM has access to the memory device using the VM secured portion access key;
in response to the first determination, synchronizing the memory device write request into a write request sequence using the write counter; and
writing the write data to the memory device based on the write request sequence.

12. The non-transitory machine-readable medium of claim 11, wherein the memory device write request is for writing the write data into a secured portion of the memory device, writing the write data to the memory device comprises writing the write data into a field of the secured portion, the memory device is non-volatile memory, the secured portion is a relay protected memory block (RPMB) of the non-volatile memory.

13. The non-transitory machine-readable medium of claim 12, wherein the operations are performed by a management entity hosted by the data processing system, and, among all other components and resources of the data processing system including the VM, only the management entity is able to access the RPMB of the memory device.

14. The non-transitory machine-readable medium of claim 13, wherein the VM secured portion access key unique to the VM is created and provisioned to the VM by a VM key engine of the management entity, and operations of the management entity are not accessible to a user of the data processing system through an operating system of the data processing system.

15. The non-transitory machine-readable medium of claim 11, wherein making a first determination that the VM has access to the memory device using the VM secured portion access key comprises:
making a second determination that the VM secured portion access key included in the memory device write request matches a VM secured portion access key that was previously issued to the VM before the obtaining of the memory device write request.

16. A data processing system comprising:
a processor; and
a memory device coupled to the processor, wherein memory device stores instructions that causes the data processing system to perform operations for managing access to the memory device, the memory device being shared between a plurality of abstracted resources hosted on the data processing system, the operations comprising:
obtaining a memory device write request from a virtual machine (VM) being hosted on the data processing system, the memory device write request comprising at least a VM secured portion access key unique to the VM, a write counter, and write data;
making a first determination that the VM has access to the memory device using the VM secured portion access key;
in response to the first determination, synchronizing the memory device write request into a write request sequence using the write counter; and
writing the write data to the memory device based on the write request sequence.

17. The data processing system of claim 16, wherein the memory device write request is for writing the write data into a secured portion of the memory device, writing the write data to the memory device comprises writing the write data into a field of the secured portion, the memory device is non-volatile memory, the secured portion is a relay protected memory block (RPMB) of the non-volatile memory.

18. The data processing system of claim 17, wherein the operations are performed by a management entity hosted by the data processing system, and, among all other components and resources of the data processing system including the VM, only the management entity is able to access the RPMB of the memory device.

19. The data processing system of claim 18, wherein the VM secured portion access key unique to the VM is created and provisioned to the VM by a VM key engine of the management entity, and operations of the management entity are not accessible to a user of the data processing system through an operating system of the data processing system.

20. The data processing system of claim 16, wherein making a first determination that the VM has access to the memory device using the VM secured portion access key comprises:
making a second determination that the VM secured portion access key included in the memory device write request matches a VM secured portion access key that was previously issued to the VM before the obtaining of the memory device write request.
